(19) United States
(12) Patent Application Publication
(10) Pub. No.: US 2012/0166144 A1
(43) Pub. Date: Jun. 28, 2012

(54) DEVICE CHARACTERISTICS MEASUREMENT METHOD USING AN ALL-OPTOELECTRONIC TERAHERTZ PHOTOMIXING SYSTEM AND SPECTRAL CHARACTERISTICS MEASUREMENT METHOD OF TERAHERTZ MEASURING APPARATUS USING THE SAME

(75) Inventors: Han-Cheol Ryu, Daejeon (KR); Min Hwan Kwak, Daejeon (KR); Seung beom Kang, Chungcheongbuk-do (KR); Sungil Kim, Daejeon (KR); Dong Suk Jun, Daejeon (KR); Mun Cheol Paek, Daejeon (KR); Kwang Yong Kang, Daejeon (KR)

(73) Assignee: ELECTRONICS AND TELECOMMUNICATIONS RESEARCH INSTITUTE, Daejeon (KR)

(21) Appl. No.: 13/278,195

(22) Filed: Oct. 21, 2011

(30) Foreign Application Priority Data
Dec. 23, 2010 (KR) 10-2010-0134049

(51) Int. Cl. G06F 15/00

(52) U.S. Cl. 702/189

(57) ABSTRACT

A device characteristics measurement method using an all-optoelectronic terahertz photomixing system includes: calculating power of an antenna of a transmitter by adding a matching condition between output impedance of the photomixer and input impedance of the antenna of the transmitter to power of the photomixer of the transmitter; calculating power of an antenna of a receiver based on the power of the antenna of the transmitter; and outputting the power of the antenna of the transmitter and the power of the antenna of the receiver so as to analyze device characteristics of the photomixer and the antenna of the transmitter.

### CROSS-REFERENCES TO RELATED APPLICATIONS

The present application claims priority under 35 U.S.C 119(a) to Korean Application No. 10-2010-0134049, filed on Dec. 23, 2010, in the Korean intellectual property Office, which is incorporated herein by reference in its entirety set forth in full.

### BACKGROUND

Exemplary embodiments of the present invention relate to a method for measuring spectral characteristics using an all-optoelectronic terahertz photomixing system, and more particularly, to a method for measuring spectral characteristics of a terahertz photomixer and an antenna device and measuring spectral characteristics of a terahertz measuring apparatus through the measured spectrums by using an all-optoelectronic terahertz photomixing system in a terahertz frequency band.

A terahertz band ranging from 100 GHz to 10 THz is a frequency band which exists in a boundary region between light waves and radio waves and has been developed most recently. In order to reclaim the terahertz band, new electromagnetic wave technology using recent laser technology and semiconductor technology has been developed.

A terahertz electromagnetic wave oscillates in a pulse wave form using a high-speed photoconductive antenna (switch) based on femto-second optical pulses or a continuous wave form using an optical heterodyne method based on a photomixer.

A terahertz continuous wave system has advantages in terms of frequency selectivity, price, size, and measurement time, compared with a terahertz pulse wave system. Much intention has been paid to the terahertz continuous wave system as a terahertz spectroscopy or an imaging measurement system. In the optical heterodyne method, when two continuous wave laser beams having the same intensity and a slight frequency difference are incident on a photomixer formed on a photoconductive thin film such as low temperature grown GaAs (LTG-GaAs), in which a carrier lifetime is as short as a pico second or less, so as to be aligned with a wave front, current modulation of a terahertz band corresponding to a difference frequency occurs. The generated current is radiated as a terahertz electromagnetic wave through an antenna.

The above-described configuration is a related art for helping an understanding of the present invention, and does not mean a related art which is widely known in the technical field to which the present invention pertains.

In order to apply a conventional terahertz wave to applied technology or improve the performance of a device, it is very important to analyze spectral characteristics of a terahertz wave of the developed device and measure power based the spectral characteristics.

In the case of a general terahertz wave, or particularly, a continuous wave, power thereof is as very small as 1 uw or less and thus difficult to measure. Such a terahertz wave having small power is measured by using a special terahertz measuring equipment such as a bolometer which operates at 4.2K corresponding to the temperature of liquid helium.

Furthermore, the conventional terahertz measuring equipment such as a bolometer has performed spectrum correction by using black body radiation and a Fourier transform infrared spectroscopy (FT-IR) method. However, such a correction method is very complex, and it is not easy to perform the correction in a terahertz band.

### SUMMARY

An embodiment of the present invention relates to a method for analyzing terahertz photomixer/antenna spectral characteristics in a terahertz frequency band by measuring spectral characteristics of a terahertz measuring apparatus and correcting a frequency band of a terahertz measuring equipment such as a bolometer.

In one embodiment, a device characteristics measurement method using an all-optoelectronic terahertz photomixing system includes: calculating power of an antenna of a transmitter by adding a matching condition between output impedance of the photomixer and input impedance of the antenna of the transmitter to power of the photomixer of the transmitter; calculating power of an antenna of a receiver based on the power of the antenna of the transmitter; and outputting the power of the antenna of the transmitter and the power of the antenna of the receiver so as to analyze device characteristics of the photomixer and the antenna of the transmitter.

The power of the antenna of the transmitter may be calculated by the following equation:

$${P}_{A\_THz} ( ω ) = {η}_{c} ( 1 - {\vert Γ \vert}^{2} ) \frac{{R}_{A} ( ω ) {τ}^{2}}{( 1 + {( ωτ )}^{2} ) ( 1 + {( ω {R}_{A} ( ω ) C ( ω ) )}^{2} )} ,$$

where η_{c} is photoelectron conversion efficiency which is decided based on power, quantum, and mixing efficiency of incident light, an applied voltage, mobility of a photoconductor, and the form of the photomixer, τ represents an optical carrier lifetime, Γ represents a reflection coefficient between the photomixer and the antenna of the transmitter and is defined as (Zₐₙₜ−Zₘᵢₓₑᵣ)/(Zₐₙₜ−Zₘᵢₓₑᵣ), Zₐₙₜ and Zₘᵢₓₑᵣ represent the input impedance of the antenna of the transmitter and the output impedance of the photomixer, respectively, (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance.

The power of the antenna of the receiver may be calculated by the following power transmission formula:

$${P}_{r} = {P}_{t} \frac{{G}_{t} {G}_{r} {λ}^{2}}{{( 4 π R )}^{2}} ,$$

where Pᵣ represents the power of the antenna of the receiver, and Pₜ represents the power of the antenna of the transmitter, Gₜ represents a gain of the antenna of the transmitter, Gᵣ represents a gain of the antenna of the receiver, and Gₜ and Gᵣ are set to constants in the entire frequency band.

The power of the antenna of the receiver may be calculated by the following equation:

$${P}_{R \_ THz} ( ω ) ∝ ( 1 - {\vert Γ \vert}^{2} ) \frac{{R}_{A} ( ω ) {τ}^{2}}{{ω}^{2} ( 1 + {( ωτ )}^{2} ) ( 1 + {( ω {R}_{A} ( ω ) C ( ω ) )}^{2} )}$$

where (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance, τ represents an optical carrier lifetime, and Γ represents a reflection coefficient between the photomixer and the antenna of the transmitter.

The photomixer may have capacitor characteristics in any one of an interdigitated type, a gap type, and a multilayer type.

The antenna of the transmitter may have broadband characteristics and resonant characteristics.

In another embodiment, there is provided a spectral characteristics measurement method of a terahertz measuring apparatus using a device characteristics measurement method using an all-optoelectronic terahertz photomixing system. The spectral characteristics measurement method includes: calculating power of an antenna of a transmitter by adding a matching condition between output impedance of the photomixer and input impedance of the antenna of the transmitter to power of the photomixer of the transmitter in the all-optoelectronic terahertz photomixing system; calculating power of an antenna of a receiver based on the power of the antenna of the transmitter and a power transmission formula used in a communication link; calculating a propagation loss between the antenna of the transmitter and the antenna of the receiver, and compensating terahertz power of the antenna of the receiver for the propagation loss; and outputting terahertz power measured by the terahertz measuring apparatus connected to a receiver stage of the all-optoelectronic terahertz photomixing system and the compensated terahertz power so as to correct spectral characteristics of the terahertz measuring apparatus.

The power of the antenna of the transmitter may be calculated by the following equation:

$${P}_{A \_ THz} ( ω ) = {η}_{c} ( 1 - {\vert Γ \vert}^{2} ) \frac{{R}_{A} ( ω ) {τ}^{2}}{( 1 + {( ωτ )}^{2} ) ( 1 + {( ω {R}_{A} ( ω ) C ( ω ) )}^{2} )} ,$$

where η_{c} is photoelectron conversion efficiency which is decided based on power, quantum, and mixing efficiency of incident light, an applied voltage, mobility of a photoconductor, and the form of the photomixer, τ represents an optical carrier lifetime, Γ represents a reflection coefficient between the photomixer and the antenna of the transmitter and is defined as (Zₐₙₜ−Zₘᵢₓₑᵣ)/(Zₐₙₜ−Zₘᵢₓₑᵣ), Zₐₙₜ and Zₘᵢₓₑᵣ represent the input impedance of the antenna of the transmitter and the output impedance of the photomixer, respectively, (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance.

The power of the antenna of the receiver may be calculated by the following power transmission formula:

$${P}_{r} = {P}_{t} \frac{{G}_{t} {G}_{r} {λ}^{2}}{{( 4 π R )}^{2}} ,$$

where Pᵣ represents the power of the antenna of the receiver, and Pₜ represents the power of the antenna of the transmitter, Gₜ represents a gain of the antenna of the transmitter, Gᵣ represents a gain of the antenna of the receiver, and Gₜ and Gᵣ are set to constants in the entire frequency band.

The power of the antenna of the receiver may be calculated by the following equation:

$${P}_{R \_ THz} ( ω ) ∝ ( 1 - {\vert Γ \vert}^{2} ) \frac{{R}_{A} ( ω ) {τ}^{2}}{{ω}^{2} ( 1 + {( ωτ )}^{2} ) ( 1 + {( ω {R}_{A} ( ω ) C ( ω ) )}^{2} )} ,$$

where (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance, τ represents an optical carrier lifetime, and Γ represents a reflection coefficient between the photomixer and the antenna of the transmitter.

### BRIEF DESCRIPTION OF THE DRAWINGS

The above and other aspects, features and other advantages will be more clearly understood from the following detailed description taken in conjunction with the accompanying drawings, in which:

FIG. 1 schematically illustrates an all-optoelectronic terahertz photomixing system constructed by using only terahertz photoconductive devices, to which the present invention may be applied;

FIG. 2 is a flow chart showing a device characteristics measurement method using the all-optoelectronic terahertz photomixing system in accordance with the embodiment of the present invention'

FIG. 3 is an equivalent circuit diagram of an integrated terahertz photomixer/antenna device;

FIG. 4 is a graph showing input resistance of a log periodic antenna used as a transmitter/receiver in FIG. 1;

FIG. 5 is a graph showing capacitance of an interdigitated photomixer used as the transmitter/receiver in FIG. 1;

FIG. 6 is a graph showing a reflection coefficient of an antenna and an impedance mismatch factor which are calculated in a state in which port impedance of the antenna is set to 100 kΩ;

FIG. 7 is a graph comparatively showing a signal-to-noise ratio (SNR) calculated by analyzing the system and a measured SNR;

FIG. 8 is a flow chart showing a spectral characteristics measurement method of a terahertz measuring apparatus using the device characteristics measurement method using the all-optoelectronic terahertz photomixing system in accordance with the embodiment of the present invention; and

FIG. 9 is a schematic view of a terahertz wave region in the all-optoelectronic terahertz photomixing system which is constructed by increasing the number of parabolic mirrors to four, to which the present invention may be applied.

### DESCRIPTION OF SPECIFIC EMBODIMENTS

Hereinafter, a method for measuring spectral characteristics of an integrated photomixer/antenna device in a terahertz band in accordance with an embodiment of the present invention will be described in detail with reference to the accompanying drawings. The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms are based on the descriptions of the entire present specification.

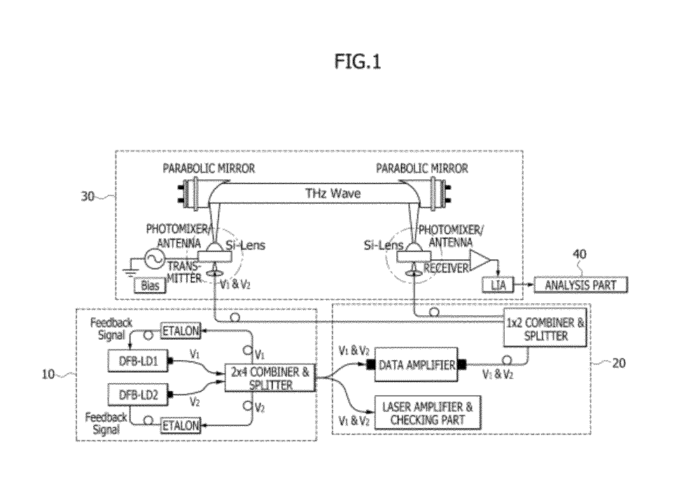

FIG. 1 schematically illustrates an all-optoelectronic terahertz photomixing system constructed by using only terahertz optoelectronic devices, to which the present invention may be applied.

Referring to FIG. 1, the all-optoelectronic terahertz photomixing system to which the present invention may be applied includes a laser & feedback control part 10, a laser amplifier & checking part 20, a terahertz transmitter/receiver system 30, and an analysis part 40.

The laser & feedback control part 10 is configured to generate two lasers used for generating a terahertz radio wave. Here, the two lasers used for generating a terahertz radio wave have wavelengths of 853 nm and 855 nm, respectively. Furthermore, two optical outputs v₁ and v₂ are incident on a 2×4 combiner & splitter using optical fiber in which polarized waves are maintained, and 1% of the respective incident optical outputs are circulated in a feedback loop through etalons, a first distributed laser diode DFB-LD1, and a second distributed laser diode DFB-LD2, thereby improving frequency stability and power.

One of main outputs of the 2×4 combiner & splitter of the laser & feedback control part 10 is inputted to a tapered amplifier of the laser amplifier & checking part 20. The other is inputted to a laser state checking optics and used for checking the power and stability of the lasers.

An output of the tapered amplifier is inputted to a 1×2 combiner & splitter. The 1×2 combiner & splitter outputs laser beams having two wavelengths at the same power through 50:50 optical fiber power distribution.

The terahertz transmitter/receiver system 30 includes two integrated photomixer/antenna devices, and the laser beams having two wavelengths are condensed into the two integrated photomixer/antenna devices, respectively.

Here, the two integrated photomixer/antenna devices into which the two laser beams are condensed operate as a terahertz transmitter and a terahertz receiver, respectively, in the all-optoelectronic terahertz photomixing system.

A terahertz wave outputted from the transmitter is reflected by two parabolic mirrors and then inputted to the receiver, and an output of the receiver is measured by a look in amplifier (LIA).

For reference, the all-optoelectronic terahertz photomixing system is not limited to the above-described embodiment, but may include various systems for generating a terahertz continuous wave.

The analysis part is configured to analyze the reception output received by the LIA to analyze the above-described photomixer/antenna devices.

In this case, the analysis part adds an impedance mismatch factor, that is, a ratio of powers transmitted to the antenna of the transmitter from the photomixer, which is decided by a ratio of output impedance of the photomixer to input impedance of the antenna.

Furthermore, a power transmission formula used in communication link is used to calculate power received by the antenna of the receiver.

In this case, the power received by the antenna of the receiver is calculated by adding the impedance mismatch factor and applying the power transmission formula used in the communication link.

Through the analysis result of the analysis part, device characteristics and spectral characteristics of the all-optoelectronic terahertz photomixing system are analyzed.

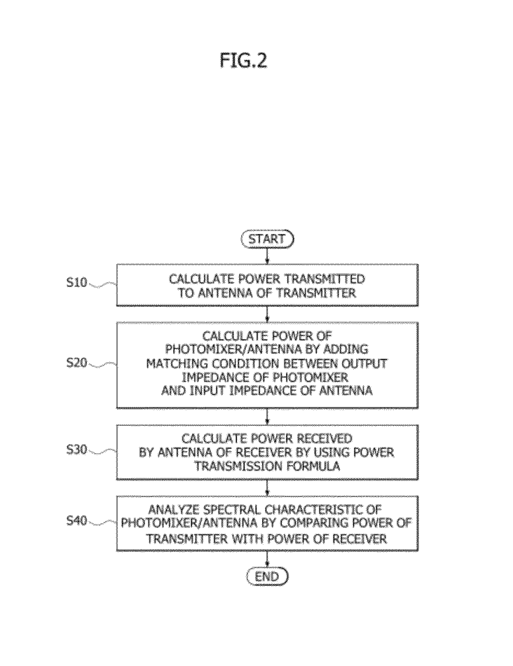

Hereinafter, a device characteristics measurement method using the all-optoelectronic terahertz photomixing system in accordance with the embodiment of the present invention will be described with reference to FIG. 2.

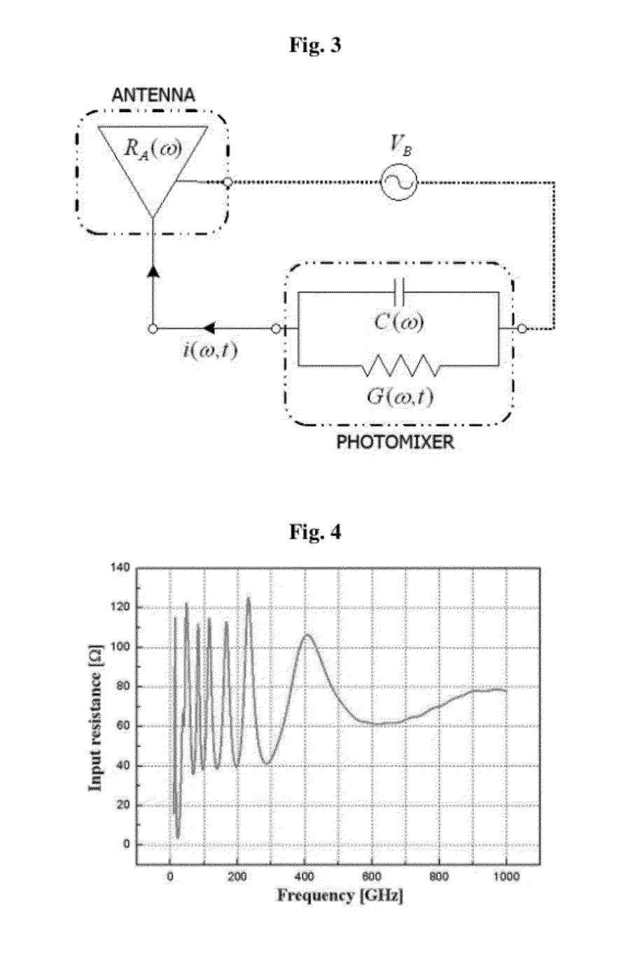

FIG. 2 is a flow chart showing the device characteristics measurement method using the all-optoelectronic terahertz photomixing system in accordance with the embodiment of the present invention. FIG. 3 is an equivalent circuit diagram of an integrated terahertz photomixer/antenna device.

First, the device characteristics measurement method using the all-optoelectronic terahertz photomixing system will be described.

Referring to FIGS. 1 and 3, a photomixing process is performed as follows: two laser beams having a slight wavelength difference are incident on a photomixer formed on a photoconductor to generate electrons, the generated electrons are accelerated by a voltage applied to the photomixer, and a terahertz wave is generated from the antenna.

At this time, since the wavelength region of the laser beams incident on the photomixer falls within a band which is much smaller than the electron lifetime of the photoconductor, light having an effect upon terahertz power is limited to the wavelength difference between the two laser beams.

Based on this, power transmitted to the antenna of the transmitter is first calculated at step S10.

For this operation, momentary power incident on the photomixer is calculated. The momentary power incident on the photomixer is expressed as Equation 1 below.

P(ω,t)=P₁+P₂+2\sqrt{mP₁P₂} cos(ω,t) [Equation 1]

Here, ω=2π((ν₁−ν₂), v₁ and v₂ represent frequencies of two incident laser beams, P₁ and P₂ represent powers of the two laser beams, and m represents spatial superposition efficiency between the two laser beams and ranges from 0 to 1.

Meanwhile, the density of optical carriers generated from a photoconductive gap of the photomixer is decided as the value of Equation 2 below.

$$\frac{d n}{d t} = \frac{η}{hvAd} P ( ω , t ) - \frac{n}{τ} \qquad [ Equation 2 ]$$

Here, n represents momentary optical carrier density, η represents quantum efficiency, A represents an effective area, d represents a light absorption depth, hv represents average energy of incident photons, and τ represents a carrier lifetime.

Referring to FIG. 1, the momentary power transmitted to the antenna may be expressed as Equation 3 below.

$${P}_{A} ( ω , t ) = {{R}_{A} ( ω ) [ \frac{{V}_{B}}{{R}_{A} ( ω ) + {[ G ( ω , t ) + jω C ( ω ) ]}^{- 1}} ]}^{2} \qquad [ Equation 3 ]$$

When the momentary power transmitted to the antenna is calculated in such a manner, an average of power which changes with time is obtained from Equation 3, and constant values are removed.

Furthermore, a matching condition between the output impedance of the photomixer and the input impedance of the antenna of the transmitter is added to calculate the power of the integrated photomixer/antenna device at step S20.

The power of the integrated photomixer/antenna device to which the matching condition between the output impedance of the photomixer and the input impedance of the antenna of the transmitter is added may be expressed as Equation 4 below.

$${P}_{A \_ THz} ( ω ) = {η}_{c} ( 1 - {\vert Γ \vert}^{2} ) \frac{{R}_{A} ( ω ) {τ}^{2}}{( 1 + {( ωτ )}^{2} ) ( 1 + {( ω {R}_{A} ( ω ) C ( ω ) )}^{2} )} \qquad [ Equation 4 ]$$

Here, η_{c} is defined as photoelectron conversion efficiency which is decided based on the power, quantum, and mixing efficiency of incident light, an applied voltage, the mobility of photoconductor, and the form of the photomixer. Furthermore, Γ represents a reflection coefficient between the photomixer and the antenna of the transmitter, and is defined as (Zₐₙₜ−Zₘᵢₓₑᵣ)/(Zₐₙₜ−Zₘᵢₓₑᵣ). Zₐₙₜ and Zₘᵢₓₑᵣ represents the input impedance of the antenna of the transmitter and the output impedance of the photomixer, respectively.

In Equation 4, an impedance mismatch factor, that is, (1−|Γ|²) represents a ratio of power transmitted from the photomixer to the antenna of the transmitter, which is decided as the ratio of the input impedance of the antenna of the transmitter to the output impedance of the photomixer.

Equation 4 indicates that terahertz power radiated from the antenna of the transmitter is closely related to the lifetime of an optical carrier, the capacitance of the photomixer, and the input impedance of the antenna of the transmitter.

As described above, Equation 4 is an equation for calculating the power of the integrated photomixer/antenna device to which the matching condition between the output impedance of the photomixer and the input impedance of the antenna of the transmitter is added. By associating the Equation 4 with a power transmission formula applied to a general communication link, power received by the antenna of the receiver can be calculated at step S30.

That is, in order to analyze the spectral characteristics of the integrated photomixer/antenna device in the all-optoelectronic terahertz photomixing system, the power transmission formula was used by considering the system to be a simple communication link having the same antenna.

The power transmission formula used in the communication link may be expressed as Equation 5 below.

$${P}_{r} = {P}_{t} \frac{{G}_{t} {G}_{r} {λ}^{2}}{{( 4 π R )}^{2}} \qquad [ Equation 5 ]$$

Here, Pᵣ represents power of the antenna of the receiver, and Pₜ represents power of the antenna of the transmitter. In the embodiment of the present invention, a relative value of power is to be analyzed instead of an absolute value thereof. Therefore, gains of the transmitting and receiving antennas, represented by Gₜ and Gᵣ in Equation 5, are set to constants in the entire frequency band. Therefore, the power represented by the receiving antenna in the present system may be expressed as Equation 6 below.

$${P}_{R \_ THz} ( ω ) ∝ ( 1 - {\vert Γ \vert}^{2} ) \frac{{R}_{A} ( ω ) {τ}^{2}}{{ω}^{2} ( 1 + {( ωτ )}^{2} ) ( 1 + {( ω {R}_{A} ( ω ) C ( ω ) )}^{2} )} \qquad [ Equation 6 ]$$

A value measured by the all-optoelectronic terahertz photomixing system is a photoelectric current, and the square of the measured photoelectric current is proportional to power. Therefore, the reception power predicted by Equation 6 may be compared with the square of the received photoelectric current.

As described above, the matching condition between the output impedance of the photomixer and the input impedance of the antenna of the transmitter is added, and the power transmission formula is used to calculate the power received by the receiving antenna. Then, based on the calculated power, it is possible to analyze the spectral characteristics of the photomixer/antenna device.

That is, as the power from the transmitter and the power from the receiver are outputted in such a manner as to compare the characteristics of the photomixer and the antenna, the characteristics of the photomixers and the antennas used in the transmitter and the receiver may be analyzed at step S40. The power transmitted from the integrated configuration of the photomixer and the antenna of the transmitter may be estimated based on the power received at the integrated configuration of the photomixer and the antenna of the receiver.

Through this operation, it is possible to check the characteristics of the integrated configuration of the photomixer and the antenna of the transmitter. Furthermore, the characteristics analysis of the photomixer/antenna devices may be additionally applied to design for device performance improvement.

An analysis example based on the device characteristics measurement method using the all-optoelectronic terahertz photomixing system in accordance with the embodiment of the present invention will be described with reference to FIGS. 4 to 7.

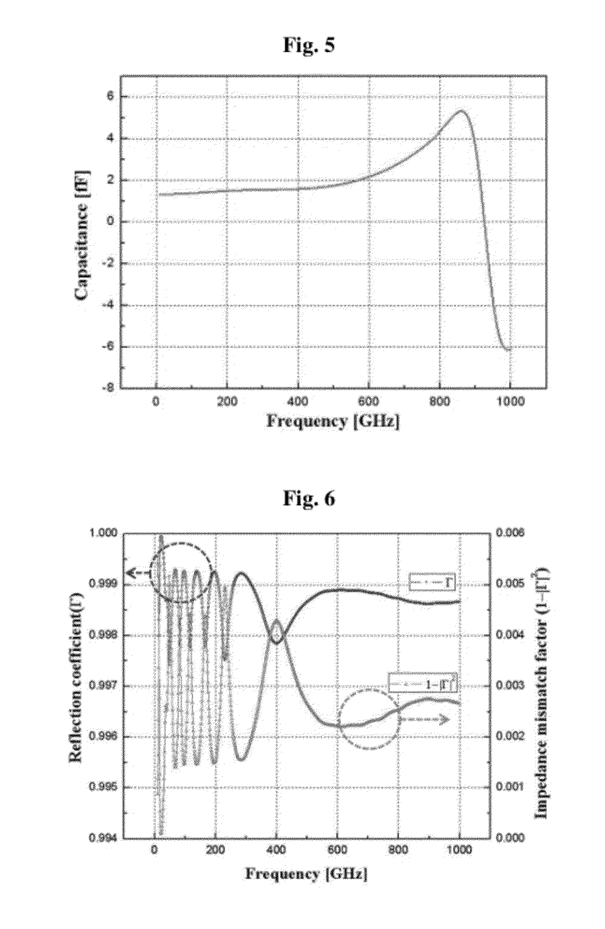

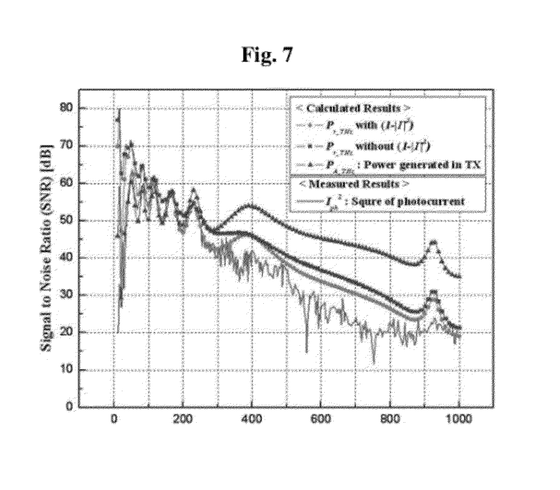

FIG. 4 is a graph showing input resistance of a log periodic antenna used as the transmitter/receiver in FIG. 1. FIG. 5 is a graph showing capacitance of an interdigitated photomixer used as the transmitter/receiver in FIG. 1. FIG. 6 is a graph showing a reflection coefficient of an antenna and an impedance mismatch factor which are calculated in a state in which the port impedance of the antenna is set to 100 kΩ. FIG. 7 is a graph comparatively showing a signal-to-noise ratio (SNR) calculated by analyzing the system and a measured SNR.

In order to verify the analysis method based on the all-optoelectronic terahertz photomixing system, the input impedance of the antenna of the transmitter and the capacitance of the photomixer were calculated by using an electromagnetic wave simulator. FIGS. 4 and 5 show the calculated input resistance of the log periodic antenna and the calculated capacitance of the interdigitated photomixer.

In FIG. 4, several peaks below 300 GHz and a peak around 400 GHz represent unique characteristics of the log periodic antenna.

FIG. 5 shows inductive characteristics over 930 GHz. Such inductive characteristics deviate from the analysis region. However, when such inductive characteristics of the photomixer are properly mixed with a reactance component of the antenna, the inductive characteristics may be effectively used for increasing the radiation efficiency of the integrated photomixer/antenna device.

The reflection coefficient between the photomixer and the antenna was calculated by using an electromagnetic simulator. At this time, when laser is condensed to the photomixer, the resistance of the photomixer was measured at 100 kΩ. Therefore, the port impedance of the antenna was set to 100 kΩ.

The impedance mismatch factor shown in FIG. 6 was as very small as 0.001 to 0.005. This means that most of the power generated by the photomixer reflects due to the impedance mismatch between the output impedance of the photomixer and the input impedance of the antenna of the transmitter. Therefore, a resonant antenna having high input impedance in a specific frequency band may be used to improve the characteristics of the impedance mismatch factor.

In order to calculate the reception power by using Equation 6, the optical carrier lifetime of the substrate of the photomixer was measured. The measured optical carrier lifetime, the input impedance of the antenna, and the capacitance of the photomixer, which are shown in FIGS. 4 and 5, were used to calculate the reception power.

FIG. 7 comparatively shows the theoretically-calculated reception power and a measured reception power. Referring to FIG. 7, it can be seen that the SNR of the measured power approaches almost 60 dB at 100 GHz and an absorption peak caused by moisture existing in the air occurs in the range of 558 GHz and 753 GHz. In order to compare the calculated power with the measured power, the entire level was corrected similarly to a power measured at 166 GHz.

FIG. 7 clearly shows the effect of the impedance mismatch factor and the power transmission formula which are used in this analysis. A power value calculated without considering the impedance mismatch factor exhibited a difference from the measured value at a ripple of 300 GHz or less and an absolute value of 500 GHz or more. Furthermore, it could be seen that a power value calculated without considering the power transmission formula has a large difference from the measured value as the frequency increases.

Meanwhile, as described above, the spectral characteristics of the integrated photomixer/antenna device in a terahertz band are analyzed to thereby control the output impedance of the photomixer and the input impedance of the antenna.

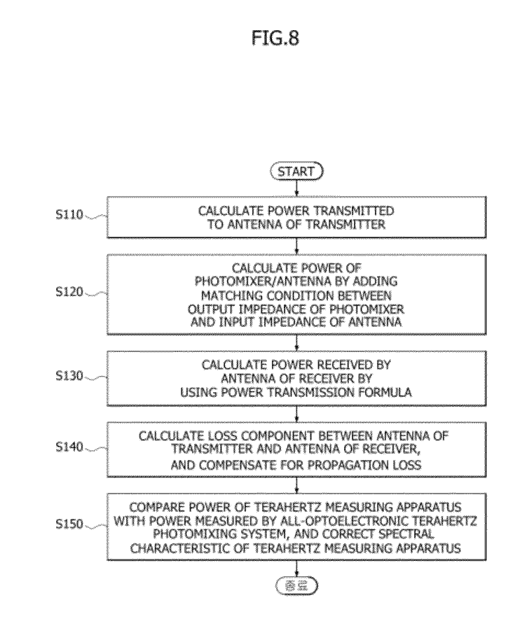

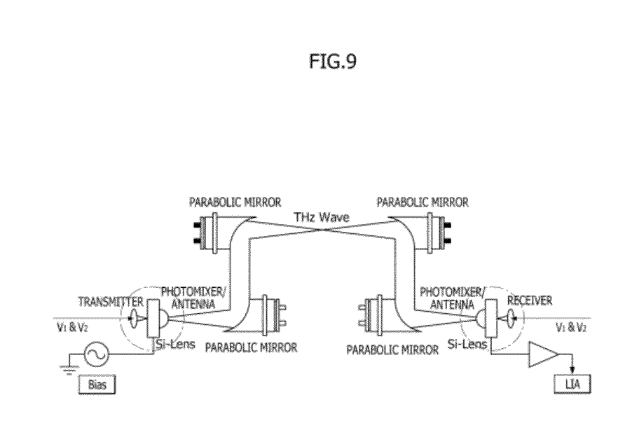

A spectral characteristics measurement method of a terahertz measuring apparatus using the device characteristics measurement method using the all-optoelectronic terahertz photomixing system in accordance with the embodiment of the present invention will be described in detail with reference to FIGS. 8 and 9.

FIG. 8 is a flow chart showing the spectral characteristics measurement method of the terahertz measuring apparatus using the device characteristics measurement method using the all-optoelectronic terahertz photomixing system in accordance with the embodiment of the present invention. FIG. 9 is a schematic view of a terahertz wave region in the all-optoelectronic terahertz photomixing system which is constructed by increasing the number of parabolic mirrors to four, to which the present invention may be applied.

For reference, the detailed descriptions of the same components as those of the device characteristics measurement method using the all-optoelectronic terahertz photomixing system will be omitted herein.

First, referring to FIG. 8, a matching condition between output impedance of a photomixer and input impedance of an antenna of the transmitter is added, and the power transmission formula is used to calculate power received by the antenna of the receiver at steps S110 to S130.

Then, a loss component between the antenna of the transmitter and the antenna of the receiver is calculated, and frequency loss characteristics are analyzed at step S140.

That is, FIG. 1 illustrates the terahertz transmitter/receiver system consisting of optoelectronic devices, which is provided with two parabolic mirrors, and FIG. 9 illustrates the terahertz transmitter/receiver system consisting of optoelectronic devices, which is provided with four parabolic mirrors.

In this case, comparing terahertz powers of the respective receivers of the system of FIG. 1 and the system FIG. 9, a loss component caused by two parabolic mirrors is calculated through loss components of four parabolic mirrors.

Through this calculation, frequency loss characteristics based on the terahertz wave may be analyzed. Therefore, the frequency loss characteristics based on the terahertz wave in FIG. 1 may be corrected.

That is, by compensating the reception power received by the receiver in FIG. 1 for the frequency loss characteristics, it is possible to acquire the terahertz wave power in the receiver.

Then, when a general terahertz measuring apparatus is connected to the receiver stage of the all-optoelectronic terahertz photomixing system of FIG. 1 to measure terahertz power, it is possible to acquire the terahertz power measured by the corresponding terahertz measuring apparatus.

Therefore, the terahertz power measured by the terahertz measuring apparatus and the terahertz power measured by the all-optoelectronic terahertz photomixing system in FIG. 1 are compared to correct the spectral characteristics of the terahertz measuring apparatus at step S150.

In this case, the spectral characteristics of the general terahertz measuring apparatus may be analyzed according to the comparison result. Therefore, the spectral characteristics of the general terahertz measuring apparatus may be corrected by various methods according to the analysis result.

In accordance with the embodiments of the present invention, it is possible to accurately analyze the spectral characteristics of the integrated photomixer/antenna or terahertz wave generation device operating in a terahertz band. Furthermore, it is possible to accurately correct the spectral characteristics of the terahertz measuring apparatus operating in a terahertz band, such as a bolometer.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A device characteristics measurement method using an all-optoelectronic terahertz photomixing system, comprising:
calculating power of an antenna of a transmitter by adding a matching condition between output impedance of the photomixer and input impedance of the antenna of the transmitter to power of the photomixer of the transmitter;
calculating power of an antenna of a receiver based on the power of the antenna of the transmitter; and
outputting the power of the antenna of the transmitter and the power of the antenna of the receiver so as to analyze device characteristics of the photomixer and the antenna of the transmitter.

2. The device characteristics measurement method of claim 1, wherein the power of the antenna of the transmitter is calculated by the following equation:
$${P}_{A \_ THz} ( ω ) = {η}_{c} ( 1 - {\vert Γ \vert}^{2} ) \frac{{R}_{A} ( ω ) {τ}^{2}}{( 1 + {( ωτ )}^{2} ) ( 1 + {( ω {R}_{A} ( ω ) C ( ω ) )}^{2} )} ,$$
where η_{c} is photoelectron conversion efficiency which is decided based on power, quantum, and mixing efficiency of incident light, an applied voltage, mobility of a photoconductor, and the form of the photomixer, Γ represents an optical carrier lifetime, Γ represents a reflection coefficient between the photomixer and the antenna of the transmitter and is defined as (Zₐₙₜ−Zₘᵢₓₑᵣ)/(Zₐₙₜ−Zₘᵢₓₑᵣ), Zₐₙₜ and Zₘᵢₓₑᵣ represent the input impedance of the antenna of the transmitter and the output impedance of the photomixer, respectively, (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance.

3. The device characteristics measurement method of claim 1, wherein the power of the antenna of the receiver is calculated by the following power transmission formula:
$${P}_{r} = {P}_{t} \frac{{G}_{t} {G}_{r} {λ}^{2}}{{( 4 π R )}^{2}} ,$$
where Pᵣ represents the power of the antenna of the receiver, and Pₜ represents the power of the antenna of the transmitter, Gₜ represents a gain of the antenna of the transmitter, Gᵣ represents a gain of the antenna of the receiver, and Gₜ and Gᵣ are set to constants in the entire frequency band.

4. The device characteristics measurement method of claim 1, wherein the power of the antenna of the receiver is calculated by the following equation:
$${P}_{R \_ THz} ( ω ) ∝ ( 1 - {\vert Γ \vert}^{2} ) \frac{{R}_{A} ( ω ) {τ}^{2}}{{ω}^{2} ( 1 + {( ωτ )}^{2} ) ( 1 + {( ω {R}_{A} ( ω ) C ( ω ) )}^{2} )} ,$$
Where (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance, τ represents an optical carrier lifetime, and Γ represents a reflection coefficient between the photomixer and the antenna of the transmitter.

5. The device characteristics measurement method of claim 1, wherein the photomixer has capacitor characteristics in any one of an interdigitated type, a gap type, and a multilayer type.

6. The device characteristics measurement method of claim 1, wherein the antenna of the transmitter has broadband characteristics and resonant characteristics.

7. A spectral characteristics measurement method of a terahertz measuring apparatus using a device characteristics measurement method using an all-optoelectronic terahertz photomixing system, the spectral characteristics measurement method comprising:
calculating power of an antenna of a transmitter by adding a matching condition between output impedance of the photomixer and input impedance of the antenna of the transmitter to power of the photomixer of the transmitter in the all-optoelectronic terahertz photomixing system;
calculating power of an antenna of a receiver based on the power of the antenna of the transmitter and a power transmission formula used in a communication link;
calculating a propagation loss between the antenna of the transmitter and the antenna of the receiver, and compensating terahertz power of the antenna of the receiver for the propagation loss; and
outputting terahertz power measured by the terahertz measuring apparatus connected to a receiver stage of the all-optoelectronic terahertz photomixing system and the compensated terahertz power so as to correct spectral characteristics of the terahertz measuring apparatus.

8. The frequency characteristics measurement method of claim 7, wherein the power of the antenna of the transmitter is calculated by the following equation:
$${P}_{A \_ THz} ( ω ) = {η}_{c} ( 1 - {\vert Γ \vert}^{2} ) \frac{{R}_{A} ( ω ) {τ}^{2}}{( 1 + {( ωτ )}^{2} ) ( 1 + {( ω {R}_{A} ( ω ) C ( ω ) )}^{2} )} ,$$
where η_{c} is photoelectron conversion efficiency which is decided based on power, quantum, and mixing efficiency of incident light, an applied voltage, mobility of a photoconductor, and the form of the photomixer, τ represents an optical carrier lifetime, Γ represents a reflection coefficient between the photomixer and the antenna of the transmitter and is defined as (Zₐₙₜ−Zₘᵢₓₑᵣ)/(Zₐₙₜ−Zₘᵢₓₑᵣ), Zₐₙₜ and Zₘᵢₓₑᵣ represent the input impedance of the antenna of the transmitter and the output impedance of the photomixer, respectively, (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance.

9. The frequency characteristics measurement method of claim 7, wherein the power of the antenna of the receiver is calculated by the following power transmission formula:
$${P}_{r} = {P}_{t} \frac{{G}_{t} {G}_{r} {λ}^{2}}{{( 4 π R )}^{2}} ,$$
where Pᵣ represents the power of the antenna of the receiver, and Pₜ represents the power of the antenna of the transmitter, Gₜ represents a gain of the antenna of the transmitter, Gᵣ represents a gain of the antenna of the receiver, and Gₜ and Gᵣ are set to constants in the entire frequency band.

10. The frequency characteristics measurement method of claim 7, wherein the power of the antenna of the receiver is calculated by the following equation:
$${P}_{R \_ THz} ( ω ) ∝ ( 1 - {\vert Γ \vert}^{2} ) \frac{{R}_{A} ( ω ) {τ}^{2}}{{ω}^{2} ( 1 + {( ωτ )}^{2} ) ( 1 + {( ω {R}_{A} ( ω ) C ( ω ) )}^{2} )} ,$$
Where (1−|Γ|²) represents a ratio of power transmitted from the photomixer to the antenna of the transmitter, which is decided by a ratio of the input impedance of the antenna of the transmitter to the output impedance of the photomixer, as the matching condition between the output impedance of the photomixer and the input impedance of the antenna of the transmitter, R_{A} represents the input impedance of the antenna of the transmitter, and C represents capacitance, τ represents an optical carrier lifetime, and Γ represents a reflection coefficient between the photomixer and the antenna of the transmitter.
